(19) United States
(12) Patent Application Publication
(10) Pub. No.: US 2006/0240233 A1
(43) Pub. Date: Oct. 26, 2006

(54) Fishing fly manufacturing devices and materials

(76) Inventors: Blane L. Chocklett, Roanoke, VA (US); Harrison L. Steeves, Blacksburg, VA (US)

Correspondence Address: TROUTMAN SANDERS LLP, 600 PEACHTREE STREET , NE, ATLANTA, GA, 30308, US

(21) Appl. No.: 11/251,081

(22) Filed: Oct. 14, 2005

Related U.S. Application Data
(63) Continuation of application No. 09/973,602, filed on Oct. 9, 2001, now Pat. No. 6,962,641.

(51) Int. Cl. B32B 7/02

(52) U.S. Cl. 428/216

(57) ABSTRACT

Fishing fly manufacturing devices and materials are provided according to the various embodiments of the present invention. In an embodiment, the fishing fly manufacturing material of the present invention includes a sheet of foil substantially uniformly adhered to a corresponding sheet of base material such as foam. Once the foil sheet is secured to the base material, the foil sheet is peeled back to disclose the foil sheet's coating transferred onto the base material. The base material is preferably flexible and resiliently compressible. Portions of the sheet of fishing fly manufacturing material may be cut to form particular shapes such as body and tail portions of fishing flies. Other embodiments are also claimed and described.

### CROSS-REFERENCE TO RELATED APPLICATION

This application is a continuation of U.S. patent application Ser. No. 09/973,602, filed 9 Oct. 2001, now U.S. Pat. No. ______, which is incorporated herein by reference in its entirety as if fully set forth below.

### TECHNICAL FIELD

The embodiments of present invention relate generally to fishing fly manufacturing devices and materials, and more particularly to devices and materials for manufacturing fishing flies constructed from various component materials capable of providing easily made fishing flies yet providing superior visual effects for angling fish.

### BACKGROUND

There are numerous arts and crafts materials available to today's hobbyists and small businesses. Most of these known materials, however, are suitable for only limited applications. One known type of material is construction paper. Although construction paper may be cut into any desired shape, it is not very durable or wetable. Also, construction paper may be used to cover a surface, but typically the paper does not adhere completely to the surface being covered. There are often gaps between the two materials which allow the two materials to separate over time. Moreover, construction paper may be easily torn.

In response to the realized inadequacies of known materials, a more versatile product is needed which can be manufactured in an economical manner. This new product must be capable of being manufactured without having portions of the product separating from one another even after the product has been cut to a particular shape or size. Moreover, this new product must be suitable for use in multiple environments such as water without being torn.

### BRIEF SUMMARY

The embodiments of present invention provide an improved fishing fly manufacturing material which may be used to manufacture a variety of fishing flies. The embodiments of the present invention provide a material to make fishing flies in an economical manner. This new material is sufficiently durable for use in a variety of environments while satisfying the need for a material which is easily cut and shaped to form a particular configuration.

Generally described, the present invention includes a sheet of material for use in manufacturing fishing flies. The fishing fly manufacturing material generally includes a sheet of thin flexible foil for enhancing the visual characteristics of the fishing fly material. A base material thicker than foil sheet underlies the foil sheet. The foil sheet is preferably substantially uniformly adhered to the base material in a substantially uniform manner. Peeling back the sheet of foil from the base material results in the foil's coating being retained on the base material. The fishing fly manufacturing material is also preferably unaltered by water and the base material is resiliently compressible. Portions of the fishing fly manufacturing material with the foil coating can be used to manufacture portions of fishing flies.

According to some embodiments of the present invention, a device for making a fishing fly comprises a base layer, a coating layer, and an adhesive layer. The base layer comprises a water insoluble material that is flexible and resilient and has a first thickness. The coating layer can be placed proximate the base layer providing a metallic visual appearance to the base material. The coating layer can be constructed of a flexible material and have a second thickness less than the first thickness. The metallic visual appearance of the coating layer can be adapted so that it does not alter when immersed in fluids, such as water. The adhesive layer is disposed between the base layer and the coating layer to substantially uniformly adhere the base layer and the coating layer. The adhesive layer comprises a water insoluble material such that when exposed to water the adhesive layer continues to adhere the base layer and the coating layer.

According to additional embodiments of the present invention, a kit for making a fishing fly comprises a plurality of sheets of material. Each of the material sheets comprises a base, an adhesive, a coating, and an applicator. The base has a first thickness and comprises a resilient compressible and non-soluble material so that the base retains it structure when immersed in water. The coating has a second thickness and a metallic visual appearance, and comprises a flexible material. The coating is adapted so that that the metallic visual appearance does not become altered or distorted when immersed in water. The adhesive is disposed between the base and the coating, and comprises a water insoluble material such that when exposed to water the adhesive continues to adhere the base layer and the coating layer. The applicator is releasably disposed upon the coating such that when the coating is brought into proximate contact with the adhesive and the applicator is removed, the coating is retained on the adhesive to provide the base with the metallic visual appearance.

In still yet additional embodiments of the present invention, a fishing fly manufacturing device comprises a thin flexible sheet of foil, a base material sheet, and an adhesive. The sheet of thin flexible foil comprises an applicator and a coating disposed upon the applicator. The foil is formed of a non-elastic water insoluble material, and the coating bears a metallic visual appearance. The sheet of base material underlies and is thicker than the foil sheet. The base material comprises a water insoluble material that is flexible, resilient, and retains its shaped when exposed to water. The adhesive is disposed between the base material and the coating, and it comprises a water insoluble material such that when exposed to water the adhesive layer continues to adhere the base material and the foil. Removal of the applicator from the foil results in the coating being retained on the adhesive, such that the base material has a metallic visual appearance.

The foregoing has outlined, rather broadly, the more pertinent and important features of the present invention. The detailed description of the invention that follows is offered so that the present contribution to the art can be more fully appreciated. Additional features of the invention will be described hereinafter. These form the subject of the claims of the invention. It should be appreciated by those skilled in the art that the conception and the disclosed specific embodiment may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

FIG. 1 illustrates a perspective view of an embodiment of a fishing fly manufacturing material of the present invention.

FIG. 2 illustrates a cross-sectional view of the fishing fly manufacturing taken along line 2-2 illustrated in FIG. 1.

FIG. 3 illustrates an exploded perspective view of the fishing fly manufacturing material illustrated in FIG. 1.

FIG. 4 illustrates an embodiment of a fishing lure of the present invention formed from portions of the fishing fly manufacturing material illustrated in FIG. 1.

FIG. 5 illustrates an alternative embodiment of a fishing lure of the present invention also formed from portions of the fishing fly manufacturing material illustrated in FIG. 1.

FIG. 6 illustrates a perspective view of the fishing fly manufacturing material illustrated in FIG. 1 with broken lines indicating various shapes which may be cut from the material.

FIGS. 7 and 8 illustrate perspective views of two elongated portions of fishing fly manufacturing material after having been cut from a sheet of fishing fly manufacturing material which are arranged to form a portion of a fishing lure according to some embodiments of the present invention.

FIG. 9 illustrates a partially assembled fishing lure according to some embodiments of the present invention formed from the portions of the fishing fly manufacturing material illustrated in FIGS. 7 and 8.

Similar reference characters refer to similar parts or components of the embodiments of the present invention throughout the several views of the drawings.

### DETAILED DESCRIPTION OF PREFERRED EMBODIMENTS

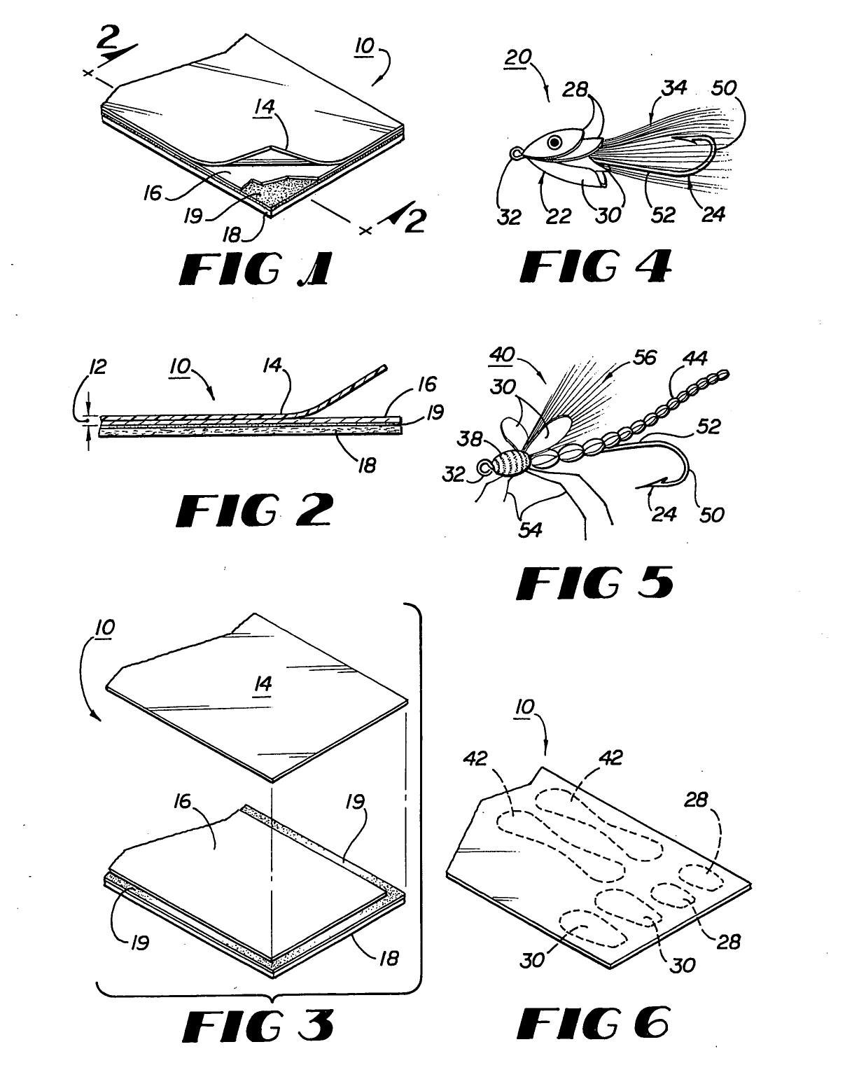

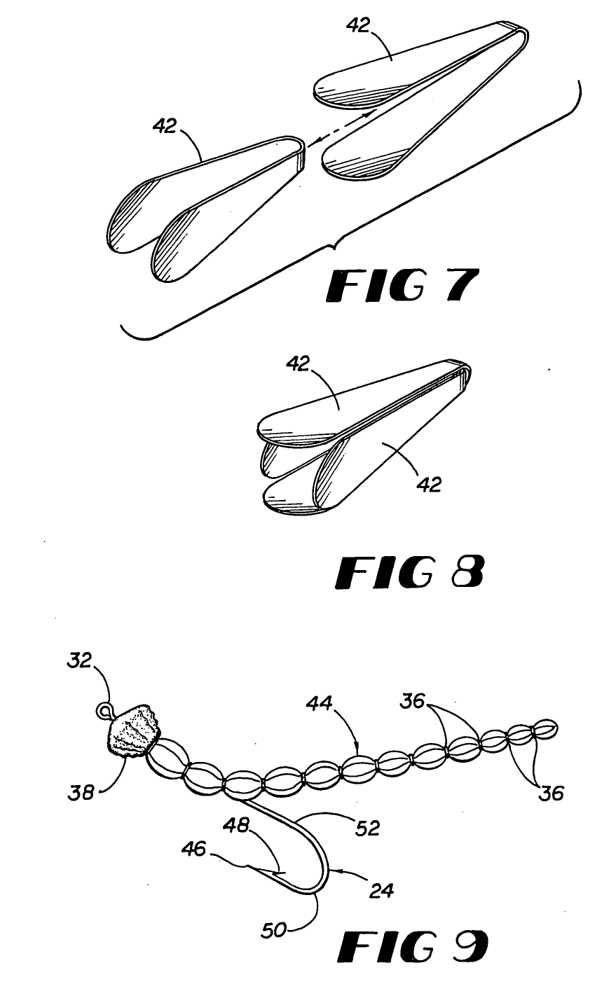

FIGS. 1-3 illustrate an exemplary embodiment of a sheet of fishing fly manufacturing material 10 of the present invention. Generally described, the sheet of material 10 includes a thin sheet of foil material 12, usually metallic and flexible. The foil 12 is commonly referred to as floppy rainbow foil and is preferably non-elastic. The foil 12 includes a disposable applicator 14 such as polyester film or other suitable means for serving as an applicator. A coating or film 16 comprising any metal or metallic compound is disposed upon the applicator 14. The foil 12 with applicator 14 and coating 16 may be purchased from Foilmark Manufacturing Corporation of Newbury Park, Calif., or from Jones Tones, Inc., of Pueblo, Colo.

The sheet of fishing fly manufacturing material 10 also includes a core or base material 18 to serve as a backing for the application of the foil 12. As shown in FIGS. 1-3, the base material 18 has a surface 2 bounded by a perimeter 4, and the surface 2 defines an area bounded by the perimeter 4. The base material 18 is thicker and more rigid than the foil 12. Typically, the base material is approximately 2 mm thick. The base material 18 is preferably insoluble and should retain its structure when immersed in a liquid such as water. In other words, the base material 18 should not disintegrate in water like ordinary paper. The base material 18, however, is flexible. The base material 18 should be easily cut with scissors or by any cutting tool.

In an embodiment of the present invention, the base material 18 is a closed-cell foam. Although synthetic materials are preferred for the base material 18, natural materials such as leather may also be used for receiving the foil 12. In a preferred embodiment, the base material 18 is resiliently compressible. In such case, the resiliently compressible base material 18, will return to a particular shape by itself. Foam base material 18 is available from Darice, Inc. of Strongsville, Ohio.

As shown in FIGS. 1-3, the foil 12 is secured to the base material 18 in substantially a uniform manner. One method for accomplishing uniform attachment of the foil 12 to the base material 18 is to use an adhesive 19 such as rubber cement. When using rubber cement, a curing period of approximately five to six minutes may be needed before securing the foil 12 and base material 18 together. The adhesive 19 is preferably a pressure sensitive adhesive. Alternatively, other types of adhesive may be used such as heat sensitive adhesives. In another alternative embodiment, foam having a sticky surface on one or both sides may be used. This type of foam is commonly referred to as sticky foam or self stick foam which is also available from Darice, Inc. of Strongsville, Ohio.

Once the sheet of foil 12 and the base material 18 are mated together, the applicator 14 is peeled from the base material 18. Peeling back the applicator 14 of the sheet of foil 12 from the base material 18 results in the foil's coating 16 being retained on the base material 18. The foil's pattern or coating 16 is maintained on the base material 18 even after extended use.

The manufacture of the fishing fly manufacturing material 10 of present invention constitutes an inventive method of the present invention in addition to the fishing fly manufacturing material 10 itself. In manufacturing the fishing fly manufacturing material 10, the first step is providing the base material 18. The inventive method then includes applying an adhesive 19 to a surface 2 of the base material 18. Next, the method includes substantially uniformly adhering a sheet of foil 12 to the surface 2 of the adhesive-coated base material 18. The sheet of foil 12 may then be pressed onto the base material 18 with the aid of a tool (not shown) such as a hand-held roller to form the sheet of fishing fly manufacturing material 10. The method then includes the step of peeling back the foil 12 from the base material 18 resulting in at least a portion of the foil's coating 16 being imprinted upon or transferred to the base material 18. The method may then further include the step of removing at least a portion of the sheet of material 10 so that the underlying base material 18 with the metallic coating may be used in an arts and craft project.

For example, fishing flies such as those shown in FIGS. 4 and 5 may be made with the use of the fishing fly manufacturing material 10. Using a bait that will tempt your quarry into taking the hook is one of the secrets of angling success. The prepared fishing fly manufacturing material 10 may be used for enhancing the visual characteristics of the fishing fly. There are numerous types of fishing flies such as, but not limited to, winged wet flies, winged dry flies, nymphs and streamers. However, all flies require realistic appearance in shape and color as well as action. Accordingly, the fishing fly manufacturing material 10 may be used to make portions of the flies in many different color patterns as well as shapes and sizes to suggest creatures such as insects.

In an embodiment, the present invention includes a kit of a plurality of sheets of fishing fly manufacturing material 10. The plurality of sheets of fishing fly manufacturing material 10 should provide different color patterns for the user to chose from when making fishing flies. When exposed to or immersed in liquids such as water, the material 10 maintains the visual appearance provided by the imprint provided by the foil 12 on the base material 18. The foil coating 16 on the outer surface of the portion of the base material 18 defining the body of the fishing fly provides a visually appealing target for a fish.

Fishing fly 20 in FIG. 4 includes body 22 secured to a hook 24. The body 22 in this embodiment is made up of overlapping portions of the fishing fly manufacturing material 10. Referring now to FIGS. 4 and 6, the body 22 has two portions 28 which partially overlap one another and two larger portions 30 which also partially overlap one another. FIG. 6 best illustrates with broken lines the portions 28 and 30 which may be removed by cutting out portions of the fishing fly manufacturing material 10 with scissors (not shown) or by other known means such as stamping. Preferably, the portions 28 and 30 are secured immediately behind the eye 32 of the hook 24 with an adhesive or with tying thread. The fishing fly 20 may also include a feathered tail 34 as shown in FIG. 4. Although a single hook 24 is shown, other types of hooks may also be used such as double or triple hooks.

FIG. 5 illustrates a fishing fly 40 of the present invention manufactured from portions 30, described above, as well as portions 42 of fishing fly manufacturing material 10. As best shown in FIGS. 7 and 8, portions 42 are folded at their midsections and interlocked with one another to form an elongated tail-like portion or body 44. Tying thread 36 may then be used along the length of the body 44 to provide the appearance that the body 44 is segmented.

FIG. 9 illustrates the body 44 of fishing fly 40 secured on the hook 24. To secure the tail 44 on the hook 24, the point 46 and barb 48 are passed through the first few segmented portions of the body 44 as best shown in FIG. 9. After the point 46 and barb 48 of the hook 24 pass through a few of the segmented portions of the body 44, these segmented portions of the body 44 are passed over the bend 50 and onto the shank 52 of the hook 24.

FIG. 5 also illustrates a head 38 of the fishing fly 40, a plurality of simulated legs 54 and a wing 56. The various elements of the flies 20 and 40 may be secured to their respective hook 24 with tying thread, adhesive or by other means known in the art.

While the various embodiments of this invention have been described in detail with particular reference to exemplary embodiments, those skilled in the art will understand that variations and modifications can be effected within the scope of the invention as defined in the appended claims. Accordingly, the scope of the various embodiments of the present invention should not be limited to the above discussed embodiments, and should only be defined by the following claims and all equivalents.

We claim:

1. A device for making a fishing fly, the device comprising:
a base layer comprising a water insoluble material that is flexible and resilient, wherein the base layer has a first thickness;
a coating layer proximate the base layer to provide a metallic visual appearance to said base material, wherein the coating layer is flexible and has a second thickness less than the first thickness, and wherein the metallic visual appearance of the coating layer does not alter when immersed in water; and
an adhesive layer disposed between said base layer and said coating layer to substantially uniformly adhere the base layer and the coating layer, wherein the adhesive layer comprises a water insoluble material such that when exposed to water the adhesive layer continues to adhere said base layer and said coating layer.

2. The device of claim 1, wherein the base material is at least one of foam, close-cell foam, leather, or a foam having two sides with an adhesive at least partially disposed on each side.

3. The device of claim 1, wherein the adhesive is at least one of a pressure sensitive adhesive, a heat sensitive adhesive, or rubber cement.

4. The device of claim 1, wherein the base layer, the coating layer, and the adhesive layer each define a perimeter, and the perimeter of each layer being approximately the same forming a sheet of fly fishing material enabling at least one predetermined shaped fishing fly to be formed from said sheet of fly fishing material.

5. The device of claim 1, further comprising an applicator, the coating layer being realeasably disposed upon the applicator to form a foil layer so that when the foil layer is disposed upon the adhesive layer and the applicator is removed at least a portion of the coating layer is retained on the adhesive layer, wherein the applicator comprises a polyester non-elastic film.

6. The device of claim 1, further comprising a fishing hook, wherein at least a portion of the base material is coupled to the fishing hook to define a body of the fishing fly, and wherein the coating layer adhered to the base material provides the body of the fishing fly with the metallic visual appearance.

7. The device of claim 6, wherein the portion of the base material is separated and removed from the base material, and wherein the portion of the base material is secured to the fishing hook to form the fishing fly.

8. A kit for making a fishing fly comprising:
a plurality of sheets of material, wherein each of the material sheets comprises a base, an adhesive, a coating, and an applicator;
the base having a first thickness and comprising a resilient compressible and non-soluble material such that the base retains it structure when immersed in water;
the coating having a second thickness and a metallic visual appearance, and comprising a flexible material, the flexible material being adapted so that the metallic visual appearance does not alter when immersed in water;
the adhesive being disposed between the base and the coating, and comprising a water insoluble material such that when exposed to water the adhesive layer continues to adhere said base layer and said coating layer; and
the applicator being releasably disposed upon the coating such that when the coating is brought into proximate contact with the adhesive, the coating is retained on the adhesive to provide the base with the metallic visual appearance.

9. The kit of claim 8, further comprising a fishing hook, wherein a portion of one of the material sheets is removed from the one material sheet and secured to the fishing hook to define the fishing fly, and wherein the adhesive within the portion continuously adheres the coating and the base of the portion so that the coating and the base do not separate.

10. The kit of claim 9, wherein the applicator is a polyester film and the adhesive is a pressure sensitive adhesive.

11. The kit of claim 8, wherein the base is more rigid and less flexible than the coating and applicator, and wherein the first thickness is greater than the second thickness.

12. A fishing fly manufacturing device comprising:
a sheet of thin flexible foil comprising an applicator and a coating disposed upon said applicator, wherein the foil is formed of a non-elastic water insoluble material, and wherein the coating has a metallic visual appearance;
a sheet of thicker base material underlying the foil sheet, the foil sheet substantially uniformly adhering to said base material, wherein the base material comprises a water insoluble material that is flexible, resilient, and retains its shaped when exposed to water;
an adhesive disposed between the base material and the coating, wherein the adhesive layer comprises a water insoluble material such that when exposed to water the adhesive layer continues to adhere; and
wherein removal of the applicator results in the coating being retained on the adhesive.

13. The device of claim 12, wherein the base material has a thickness of approximately 2 mm and comprises a synthetic material, the applicator is a polyester film, and the adhesive is a pressure sensitive adhesive.

14. The device of claim 12, wherein the coating comprises at least one of a metal and a metallic compound to provide the metallic visual appearance.

15. The device of claim 12, wherein a portion of the base material is separated and removed from the base material, and wherein the portion of the base material is secured to a fishing hook to form a fishing fly.
